(19) United States
(12) Patent Application Publication
(10) Pub. No.: US 2006/0072592 A1
(43) Pub. Date: Apr. 6, 2006

(54) Method and a system for verifying network routing information

(76) Inventors: David Andrew Graves, Monte Sereno, CA (US); Sreerupa Sen, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/959,007

(22) Filed: Oct. 4, 2004

(51) Int. Cl. H04L 12/56

(52) U.S. Cl. 370/401; 370/252

(57) ABSTRACT

Embodiments of the present invention pertain to methods and systems for verifying network routing information are described. In one embodiment, a machine-readable map that describes a network route associated with a network router is accessed. The network router is accessed in order to obtain network routing information describing a network route. The machine-readable map is compared with the network routing information. A determination is made as to whether there are any differences between the machine-readable map and the network routing information. If there are any differences, a report that includes messages describing the differences is generated.

### TECHNICAL FIELD

Embodiments of the present invention relate to network routers. More specifically, embodiments of the present invention relate to verifying network routing information.

### BACKGROUND ART

Modern networking continues to provide an improvement in communication and information access. FIG. 1 depicts a block diagram of a conventional networking system 100. As depicted in FIG. 1, resources, such as servers 110, are interconnected with a network, such as local area network 120 (LAN), and controlled by a network operations center 130 (NOC). What is commonly referred to as a “data center” includes, but is not limited to, a collection of computational devices, such as servers 110, NOC 130, switches that can be associated with a LAN 120, firewalls, and network routers, such as network router 150.

Networks are configured in different ways depending on implementation-specific details such as the type of resources associated with the network, the physical location of the resources, and the objectives of the network. Resources include, but are not limited to, computer systems, routers, switches, load balancers, firewalls, and the like, that are commonly linked to each other in networks. One common type of network configuration is a LAN 120. In actual practice, a typical LAN 120 will include a large number of resources.

The outside devices 140 include, but are not limited to, computers and network routers that are outside of the LAN 120. Network routers provide for communications between various computers. For example, network router 150 can provide communication between a particular server (referred to hereinafter as a “originating computer”) of the servers 110 that are controlled by the NOC 130 and a computer associated with the outside devices 140 (referred to hereinafter as a “destination computer”). In another example, the network routers associated with the outside devices 140 provide communication between the servers 110 and the various computers associated with the outside devices 140.

Technicians working from the NOC 130 can issue commands to control the deployment of the servers 110 associated with the NOC 130, to control the support of the infrastructure, such as network switches associated with the LAN 120, and the network routers that provide communication from the servers 110 to the outside devices 140. One problem with this approach is that it is highly manual; thus, it is time consuming and expensive.

Network routing information describes the routes that are used for communicating between various computers. The network routing information is associated with the network routers used for routing packets between the computers For example, network routers that provide communications between an originating computer and a destination computer include network routing information that describes the route between the originating computer and the destination computer. Typically, network routing information is associated with the network routers by storing the network routing information in what is known as “router tables.” Network routing information is commonly known as “routing rules.”

The network routing information can be incorrect due to many factors. For example, computers associated with the outside devices 140 may be decommissioned and a technician may forget to delete network routing information for the decommissioned computers. In another example, computers may be added to the outside devices 140 and the technician may forget to add network routing information to the network routers for the added computers. In yet another example, network routing information may be incorrect because, for example, it was entered incorrectly or because a malicious hacker modified it. Therefore there is a need for a method and a system to ensure that the network routing information is correct.

### DISCLOSURE OF THE INVENTION

The present invention provides a method and a system that ensures the network routing information is correct.

Embodiments of the present invention pertain to methods and systems for verifying network routing information are described. In one embodiment, a machine-readable map that describes a network route associated with a network router is accessed. The network router is accessed in order to obtain network routing information describing a network route. The machine-readable map is compared with the network routing information. A determination is made as to whether there are any differences between the machine-readable map and the network routing information. If there are nay differences, a report that includes messages describing the differences is generated.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts a block diagram of a conventional networking system.

FIG. 2 is a block diagram of exemplary software for verifying network routing information, according to embodiments of the present invention.

FIG. 3 depicts a dataflow diagram for verifying network routing information according to embodiments of the present invention.

FIG. 4 is a block diagram of a system for verifying network routing information that includes a utility controller, according to embodiments of the present invention.

FIG. 5 is a block diagram of a system for verifying network routing information that does not require a utility controller, according to embodiments of the present invention.

FIG. 6 depicts a flowchart for a method of verifying network routing information according to embodiments of the present invention.

The drawings referred to in this description should not be understood as being drawn to scale except if specifically noted.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

### Network Routes and Network Routing Information

As already stated, an example of a network route is the path that is used for sending a packet (also commonly referred to as a “message”) between an originating computer and a destination computer. For any set of computers, such as servers associated with a NOC or outside devices, there can be multiple routes for communicating between the computers, according to one embodiment. Further, as already discussed, network routers are used for routing a packet from an originating computer to a destination computer. Network routing information for a particular network route is defined, according to another embodiment, with values for one or more of the following:
a) an internet address for the physical gateway Internet Protocol (IP) address;
b) a subnet mask;
c) a virtual gateway IP address (for routes to virtual LANs); and/or
d) a next hop IP address (for a public routed subnet).

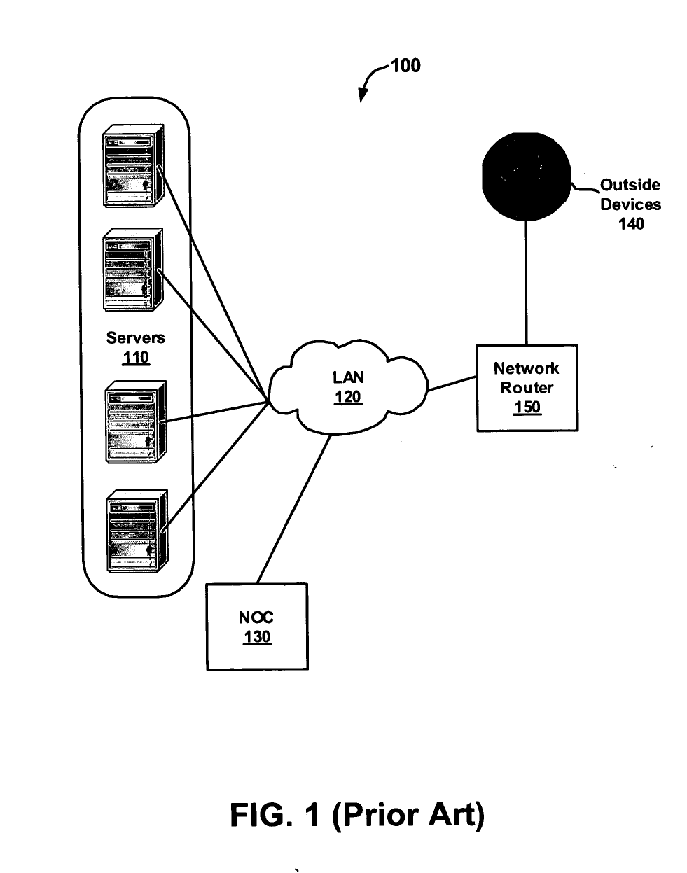

A gateway is a network router, such as network router (FIG. 1), that provides communications from one network, such as a LAN (FIG. 1), to another network, such as the networks associated with the outside devices (FIG. 1), according to one embodiment. A virtual gateway could be a network router that provides communications from a virtual LAN to another network, according to another embodiment.

A network of computers can be segmented into what is known as “network segments” (also common referred to as a “subnets”), according to one embodiment. A subnet mask is a binary value that a computer can use to determine whether a received packet could be accepted by the computer, according to one embodiment. A subnet mask can also be used to determine what machines to broadcast a packet to, according to another embodiment.

A “next hop IP address” is used to determine the next computer that a packet should be transmitted to. For example, assume that computer A is supposed to forward packets to computer B and computer B is supposed to forward packets to computer C. In this case, computer B is the next hop from computer A and computer C is the next hop from computer B.

For any given network router there is network routing information for one network route, according to one embodiment, or a plurality of network routes, according to another embodiment. For example, in some cases only two computers may communicate with each other between a particular network router, in which case, the network routing information associated with the router would describe only one network route, according to one embodiment. However, many computers can communicate with each other through a particular network router. In this case, the network routing information associated with the router could describe all of the possible network routes between the computers using that particular network router, according to another embodiment. Further, there can be a plurality of network routers for communicating between a set of computers, according to yet another embodiment.

### Utility Controller and a Map

In many cases, traditional NOCs consist of a conglomeration of many unique information technology (IT) environments. Each of the IT environments have grown and are managed for different types of needs. As such, computing resources in each of the environments of the NOCs are in part constantly being replaced, switched around, removed, added, etc.

Moreover, the IT environments are often patched together to form the NOCs. As such, the network of the computing resources can be large and complex. This patchwork infrastructure containing the IT environments in the “in-house data center” creates a number of challenges.

Utility Controllers have been created to perform “configuration steps” for the servers, switches, etc. associated with the network, and for network routers. As devices, such as servers, are deployed by the UC, information about the devices is stored in the map. The UC can accesses the map to determine the physical cabling of the devices, such as servers, associated with the network. Using a UC reduces the amount of manual processing required significantly, thus, reducing cost and human error.

According to one embodiment, a UC can be used to create and update information describing routes in the map as a part of being used to perform the “configuration steps.” According to another embodiment, the map can be created and updated manually, for example by a technician for a NOC. The map is machine-readable, according to one embodiment, and can be stored in a database, according to another embodiment.

### A Verification Program

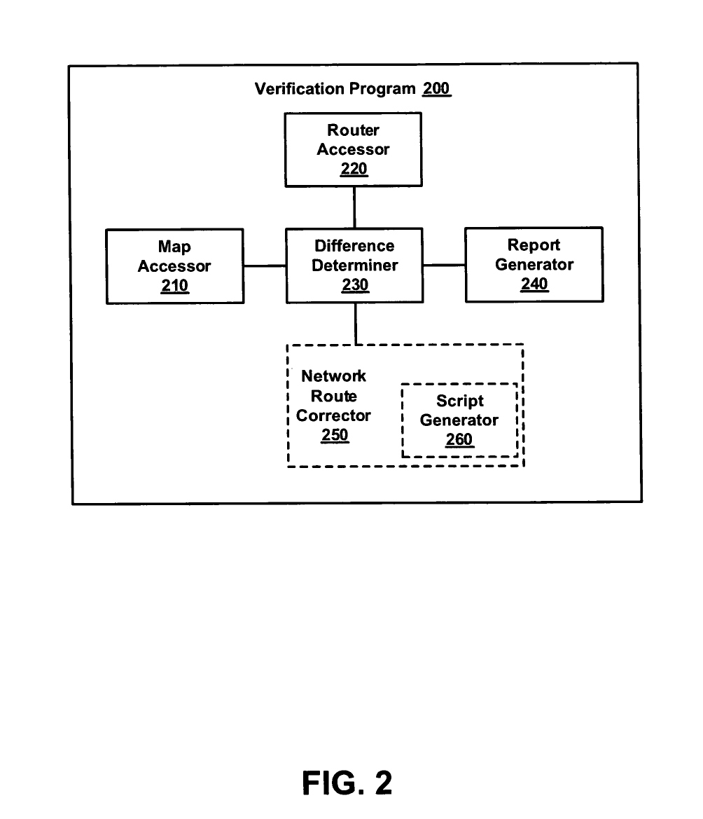

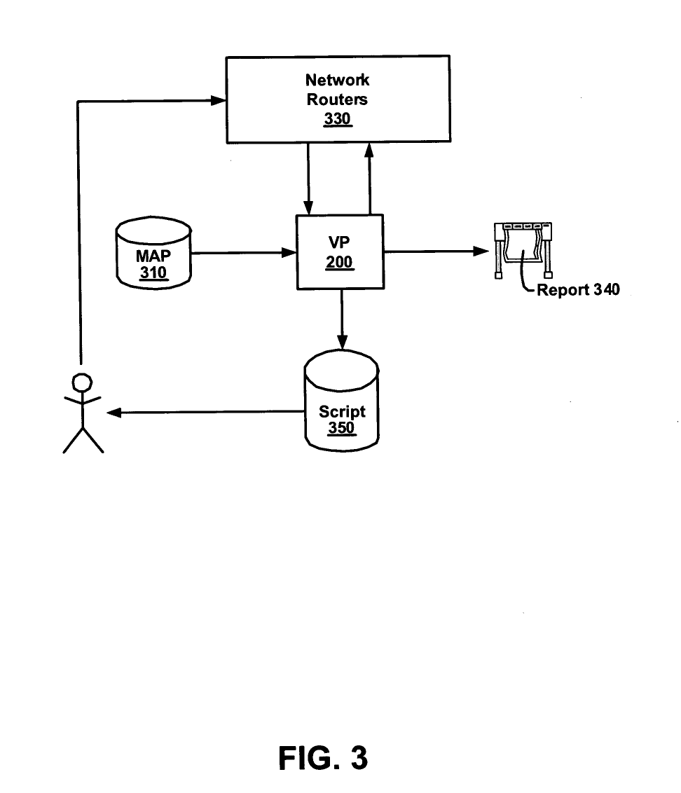

According to one embodiment, the network routing information associated with the map 310 can be used to verify and/or correct the network routing information associated with the network routers 330. FIG. 2 is a block diagram of exemplary software for verifying network routing information, according to embodiments of the present invention. The blocks in FIG. 2 can be arranged differently than as illustrated, and can implement additional or fewer features than what are described herein. FIG. 3 depicts a dataflow diagram for verifying network routing information according to embodiments of the present invention. The blocks in FIG. 3 can be arranged differently than as illustrated, and can implement additional or fewer features than what are described herein. The following description shall refer to elements that are in both FIG. 2 and FIG. 3.

The verification program 200 includes a map accessor 210, a router accessor 220, a difference determiner 230, and a report generator 240, according to one embodiment. The map accessor 210 accesses the map 310 that describes one or more network routers 330, according to one embodiment. The router accessor 220 accesses the network routers 330 to obtain the network routing information, according to another embodiment. The difference determiner 230 compares the map 310 with the network routing information, according to one embodiment, and determines whether there are any differences between the map 310 and the network routing information, according to another embodiment. The report generator 240 generates a report 340 that includes messages describing the differences, according to still another embodiment.

Optionally, the verification program 200 includes a network route corrector 250 and/or a script generator 260, according to another embodiment. Optionally, the network route corrector 250 corrects the network routing information provided there are differences between the map 310 and the network routing information, according to one embodiment. According to one embodiment, the network route corrector 250 performs these corrections automatically, and according to another embodiment, a script generator 260 generates a script 350 of instructions for correcting the network routing information provided there are differences. The script 350 can be analyzed by a person 360, such as a technician, according to one embodiment, and the person 360 can cause the script 350 to execute, according to another embodiment, provided the person determines script 350 is correct.

According to one embodiment, if there are any differences between the map 310 and the network routing information associated with the network routers 330, the network routing information is corrected to conform to the map 310. As already described herein, network routing information may need to be deleted from network routers 330, added to network routers 330, or may need to be modified. The difference determiner 230 can compare the map 310 the network routing information associated with the network routers 330 referenced in the map 310 and determine whether network routing information needs to be added, deleted, or modified, according to one embodiment. For example, if the map 310 describes routes that are not described in the network routers 330, then network routing information for those routes can be added to the network routers 330. If the map 310 does not describe routes that are described in the network routers 330, then network routing information for those routes can be deleted from the network routers 330. If the map 310 describes routes differently than the routes are described in the network routers 330, then the network routing information for those routes can be modified to conform to how the routes are described in the map 310.

### A Verification System that Includes a Utility Controller

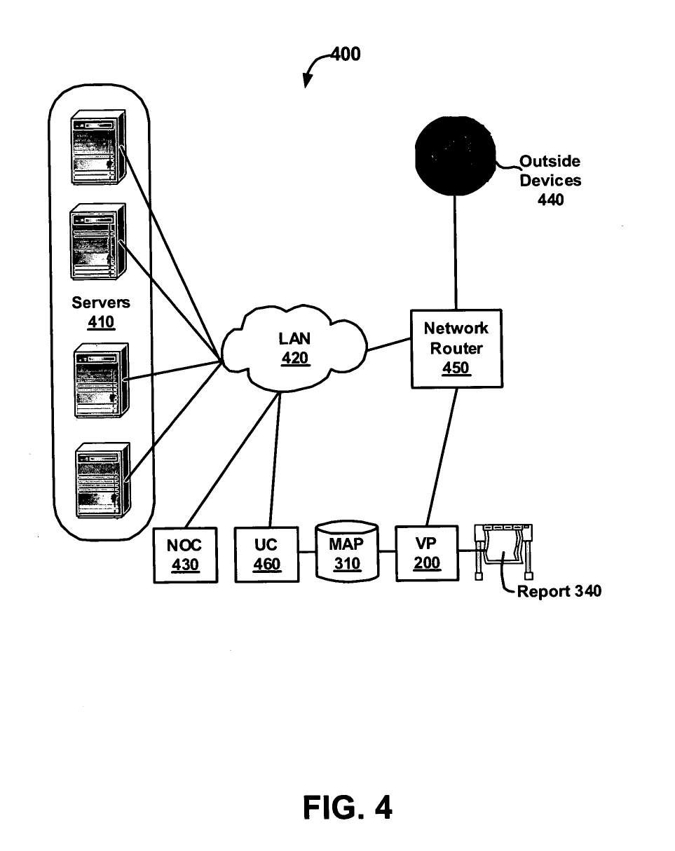

FIG. 4 is a block diagram of a system for verifying network routing information that includes a utility controller, according to embodiments of the present invention. The blocks in FIG. 4 can be arranged differently than as illustrated, and can implement additional or fewer features than what are described herein.

As depicted in FIG. 4, system 400 includes servers 410, a LAN 420, a network router 450, devices that are outside of the LAN 420 (e.g., outside devices 440), a NOC 430, a UC 460, a map 310, a verification program 200, and a report 340, according to one embodiment. The outside devices 440, include among other things, computers and network routers, according to another embodiments. The network router 450 and the network routers associated with outside devices 440 can be used to provide communication from the servers 410 to the computers associated with the outside devices 440, according to one embodiment. Network routers 330 can include network router 450 and the network routers associated with the outside devices 440, according to one embodiment.

Technicians working from the NOC 430 can issue commands to control the deployment of the servers 410 associated with the NOC 430, to control the support of the infrastructure, such as network switches associated with the LAN 420, and the network routers 330 that provide communication between the servers 410 and the computers associated with the outside devices 440. Map 310 is a machine-readable map 310, according to yet another embodiment.

The UC 460 can be used to perform configuration steps for devices, according to still another embodiment. For example, the UC 460 can be used to perform configuration steps for the servers 410, the switches associated with the LAN 420, and network routers 330, according to still another embodiment. According to one embodiment, a UC 460 can be used to create and update network routing information in the map 310 as a part of being used to perform the “configuration steps,” as already described herein. Network routers 330 includes any network routers that are used for routing packets between an “originating computer” and a “destination computer,” according to one embodiment. For example, network routers 330 can include network router 450 as well as one or more network routers associated with the outside devices 440.

A verification program 200 accesses the map 310, accesses the network routers 330 to obtain the network routing information, compares the map 310 with the network routing information, determines whether there are any differences between the map 310 and the network routing information, according to one embodiment. The verification program 200 can generate a report 340 that includes messages describing the differences, according to one embodiment, and/or correct the differences as already described herein, according to another embodiment.

### A Verification System that does not Require a Utility Controller

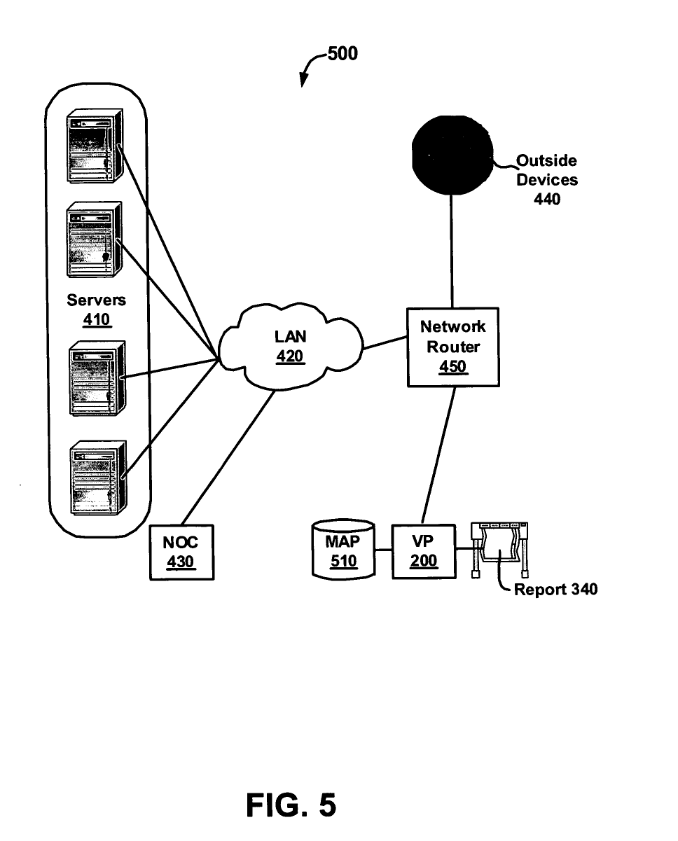

FIG. 5 is a block diagram of a system for verifying network routing information that does not require a utility controller, according to embodiments of the present invention. The blocks in FIG. 5 can be arranged differently than as illustrated, and can implement additional or fewer features than what are described herein. System 500 (FIG. 5) is similar to FIG. 4 except that a UC 460 (FIG. 4) is not associated with system 500, according to one embodiment. For example in this case, the servers 410 and the switches associated with the LAN 420 are not controlled by a UC 460 (FIG. 4) and the map 510 is not created and/or updated by a UC 460 (FIG. 4). Among other things, the map 510 can be created and updated manually, according to one embodiment. For example, the map 510 can be created and updated by technicians associated with the NOC 430.

### An Operational Example

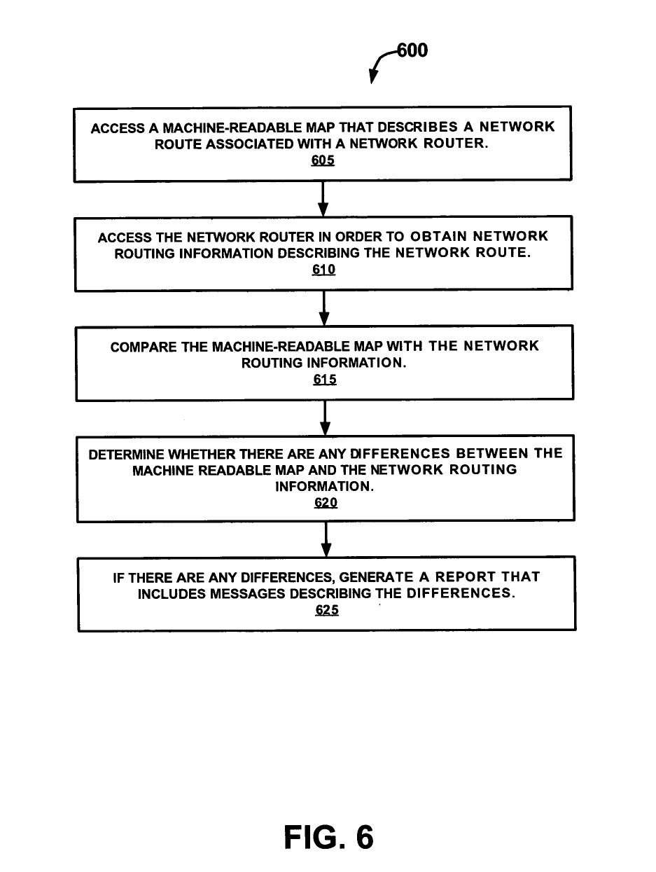

FIG. 6 depicts a flowchart for a method of verifying network routing information according to embodiments of the present invention. Although specific steps are disclosed in flowchart 600, such steps are exemplary. That is, embodiments of the present invention are well suited to performing various other steps or variations of the steps recited in flowchart 600. It is appreciated that the steps in flowchart 600 may be performed in an order different than presented, and that not all of the steps in flowchart 600 may be performed. All of, or a portion of, the embodiments described by flowchart 600 can be implemented using computer-readable and computer-executable instructions which reside, for example, in computer-usable media of a computer system or like device.

For the purposes of illustration, the discussion of flowchart 600 shall refer to the structures depicted in FIGS. 2 and 5.

For the following description of flowchart 600, assume that a malicious hacker has modified the network routing information associated with a network router Z associated with the outside devices 440. Specifically, assume that a subnet mask been modified. By broadening a subnet mask, the malicious hacker, for example, can cause a computer to receive packets (e.g., “snoop”) that the computer was not intended to receive. For example, a route for transmitting messages can be lengthen by modifying a subnet mask. More specifically, assume that computer B (e.g., a “destination computer” associated with outside devices 440) is supposed to receive messages directly from computer A (e.g., an “originating computer” associated with servers 410). By modifying the subnet mask, computer C could receive messages from computer A and then forward the messages to computer B in such a way that neither computer A nor computer B could detect that computer C is intercepting the messages.

In step 605, a machine-readable map that describes a network route associated with a network router is accessed, according to one embodiment. For example, the map 310 describes a network route X from computer A to B. The subnet mask for the network route X is a version that has not been modified by the hacker. The map accessor 210 accesses the map 510 that describes the network route X.

In step 610, the network router is accessed in order to obtain network routing information describing the network route, according to another embodiment. For example, the network router Z, according to one embodiment, has router tables with network routing information that describes the same network route X. However, the network routing information includes a modified version of the subnet mask for the network route X. The router accessor 220 accesses network router Z to obtain the network routing information that includes the modified version of the subnet mask.

In step 615, the machine-readable map is compared with the network routing information, according to yet another embodiment. For example, the difference determiner 230 compares the map 5 10 with the network routing information obtained from router Z.

In step 620, a determination is made as to whether there are any differences between the machine-readable map and the network routing information, according to still another embodiment. For example, the difference determiner 230 determines that the network route X has been modified.

In step 625, if there are any differences, a report that includes messages describing the differences is generated. For example, the report generator 240 can generate a report 340 indicating that network route X has been modified, according to one embodiment, and indicate the nature of the difference (e.g., the subnet has been broadened), according to another embodiment. According to one embodiment, the report 340 has one message per difference.

Further, the network route corrector 250 can automatically modify the network routing information for network route X stored in network router Z to have the same subnet mask as that associated with the map 510.

### Conclusion

Prior solutions have used manual procedures, where an operator or technician has logged into each network router individually, and issued commands to display the network routing information, for example, stored in a particular network router. The technician then visually compares the network routing information to the expected values and, if needed, edits the network routing information manually, for example, by issuing commands. This manual process can take at least several minutes to verify a single network router, therefore, it is time consuming, tedious, and prone to error.

By providing a verification program, embodiments of the present invention can not only be used to verify the accuracy of network routing information but can also be used to ensure accuracy of the network routing information in a manner that eliminates manual processing, thus, is fast and inexpensive. Further, there is virtually no limit to the frequency that the verification can be performed, thus, allowing verification to be performed much more frequently than if manual verification procedures were used. For example, by automating with a verification program the network routing information can be verified weekly, daily, and/or hourly, among other things.

What is claimed is:

1. A method of verifying network routing information, the method comprising:
accessing a machine-readable map that describes a first network route associated with a network router;
accessing the network router to obtain network routing information describing a second network route;
comparing the machine-readable map with the network routing information;
determining whether there are any differences between the machine-readable map and the network routing information; and
provided there is one or more differences, generating a report that includes a message describing the one or more differences.

2. The method as recited in claim 1, further comprising:
automatically correcting the network routing information provided there is the one or more differences.

3. The method as recited in claim 1, further comprising:
generating a script of instructions for correcting the network routing information provided there is the one or more differences.

4. The method as recited in claim 1, further comprising:
correcting the network routing information wherein a correction is selected from a group consisting of adding information describing the first network route in the event that the network routing information does not describe the first network route, deleting information describing the second network route in the event that the map does not describe the second network route, and modifying information describing the second network route in the event that the first network route and the second network route are the same network route.

5. The method as recited in claim 1, wherein the accessing the network router to obtain network routing information further comprises:
obtaining network routing information with values from a group consisting of an internet address for a physical gateway Internet Protocol (IP) address, a subnet mask, a virtual gateway IP address, and a next hop IP address.

6. The method as recited in claim 1, further comprising:
using a utility controller to create the machine-readable map.

7. The method as recited in claim 1, further comprising:
not requiring the use of a utility controller to create the machine-readable map.

8. A system for verifying network routing information, the system comprising:
a map accessor for accessing a machine-readable map that describes a first network route associated with a network router;
a router accessor for accessing the network router to obtain network routing information describing a second network route;
a difference determiner for determining whether there are any differences between the machine-readable map and the network routing information; and
a report generator for generating a report that includes a message describing one or more differences, provided there is the one or more differences.

9. The system of claim 8, further comprising:
a network route corrector that automatically corrects the network routing information provided there is the one or more differences.

10. The system of claim 8, further comprising:
a script generator for generating a script of instructions for correcting the network routing information provided there is the one or more differences.

11. The system of claim 8, further comprising:
a network route corrector for correcting the network routing information wherein a correction is selected from a group consisting of adding information describing the first network route in the event that the network routing information does not describe the first network route, deleting information describing the second network route in the event that the map does not describe the second network route, and modifying information describing the second network route in the event that the first network route and the second network route are the same network route.

12. The system of claim 8, wherein the network routing information includes values from a group consisting of an internet address for a physical gateway Internet Protocol (IP) address, a subnet mask, a virtual gateway IP address, and a next hop IP address.

13. The system of claim 8, further comprising:
a utility controller that creates the machine-readable map.

14. The system of claim 8, wherein:
the system does not require a utility controller to create the machine-readable map.

15. A computer-usable medium having computer-readable program code embodied therein for causing a computer system to perform a method of verifying network routing information, the method comprising:
accessing a machine-readable map that describes a first network route associated with a network router;
accessing the network router to obtain network routing information describing a second network route;
comparing the machine-readable map with the network routing information;
determining whether there are any differences between the machine-readable map and the network routing information; and
provided there is one or more differences, generating a report that includes a message describing the one or more differences.

16. The computer-usable medium as recited in claim 15, wherein the computer-readable program code embodied therein causes a computer system to perform the method, and wherein the method further comprises:
automatically correcting the network routing information provided there is the one or more differences.

17. The computer-usable medium as recited in claim 15, wherein the computer-readable program code embodied therein causes a computer system to perform the method, and wherein the method further comprises:
generating a script of instructions for correcting the network routing information provided there is the one or more differences.

18. The computer-usable medium as recited in claim 15, wherein the computer-readable program code embodied therein causes a computer system to perform the method, and wherein the method further comprises:
correcting the network routing information wherein a correction is selected from a group consisting of adding information describing the first network route in the event that the network routing information does not describe the first network route, deleting information describing the second network route in the event that the map does not describe the second network route, and modifying information describing the second network route in the event that the first network route and the second network route are the same network route.

19. The computer-usable medium as recited in claim 15, wherein the computer-readable program code embodied therein causes a computer system to perform the method, and wherein the accessing the network router to obtain network routing information further comprises:
obtaining network routing information with values from a group consisting of an internet address for a physical gateway Internet Protocol (IP) address, a subnet mask, a virtual gateway IP address, and a next hop IP address.

20. The computer-usable medium as recited in claim 15, wherein the computer-readable program code embodied therein causes a computer system to perform the method, and wherein the method further comprises:
using a utility controller to create the machine-readable map.

21. The computer-usable medium as recited in claim 15, wherein the computer-readable program code embodied therein causes a computer system to perform the method, and wherein the method further comprises:
not requiring the use of a utility controller to create the machine-readable map.

22. A data center comprising:
a collection of computational devices, wherein the collection of computation devices includes servers, switches, firewalls, and network routers;
a utility controller that creates and maintains a machine-readable map;
a verification program that comprises:
a map accessor for accessing the machine-readable map that describes a first network route associated with a network router;
a router accessor for accessing the network router to obtain network routing information describing a second network route;
a difference determiner for determining whether there are any differences between the machine-readable map and the network routing information; and
a report generator for generating a report that includes a message describing one or more differences, provided there is the one or more differences.
